(19) United States
(12) Patent Application Publication
(10) Pub. No.: US 2026/0084182 A1
(43) Pub. Date: Mar. 26, 2026

(54) Coating Process And Product Obtained From It

(71) Applicant: Jose Vicente Vazquez Ortega, Sax (ES)

(72) Inventor: Jose Vicente Vazquez Ortega, Sax (ES)

(21) Appl. No.: 18/956,028

(22) Filed: Nov. 22, 2024

(30) Foreign Application Priority Data
Sep. 26, 2024 (IT) 102024000021408

(51) Int. Cl. B05D 3/02; B05D 3/14

(52) U.S. Cl. CPC B05D 3/0227; B05D 3/0254; B05D 3/14; B05D 2506/25

(57) ABSTRACT

A process for coating a profile or panel is provided. The process comprises the following steps: a) removal of dust from the profile or panel; b) heating the profile or panel to a temperature between 30 and 70 degrees Celsius using infrared halogen lamps or similar, controlled by an automatic control system; c) exposing the profile or panel to jets of ionized air by means of electric discharges with an emission frequency between 18 Hz and 25 Hz; d) coating the profile or panel with a film of polyvinyl chloride (PVC), paper, or other desired material, previously treated with a low-isocyanate emission adhesive; e) heating the profile or panel to a temperature between 45 and 65 degrees Celsius for a time depending on the mass of material in the profile or panel. The invention also relates to a coated product obtained through the aforementioned process.

### CROSS-REFERENCE TO RELATED APPLICATIONS

This application claims priority to and the benefit of the non-provisional patent application titled “Coating Process And Product Obtained From It”, application number 102024000021408, filed in the Italian Patent and Trademark Office on Sep. 26, 2024. The specification of the above referenced patent application is incorporated herein by reference in its entirety.

### FIELD OF THE INVENTION

The present invention primarily applies to the field of coating profiles and panels. In particular, this invention refers to a process through which, starting from certain steps with innovative characteristics, it is possible to coat materials such as panels or profiles of any material, resulting in a product significantly improved compared to the known art.

The coating of profiles or panels is a process in which a surface is laminated in a straight line by means of a machine. Profile coatings are one of the trends for windows and panels made of aluminum, polyvinyl chloride (PVC), and wood-plastic composite (WPC), which achieve excellent results. They are made from highly durable materials and feature designs and characteristics that provide them with a long operational life.

### BACKGROUND

Currently, profile coatings are carried out through chemical treatment. First, a chemical primer, either solvent-based or water-based, is applied to the material to be coated, increasing the surface energy of the substrate and facilitating adhesion, followed by the coating of the profile.

For the application of chemical primers, methyl acetates or methylene chloride are usually used (the latter is highly carcinogenic, and its use is restricted). This traditional process presents numerous drawbacks, such as the use of toxic and volatile products that are difficult to eliminate, like methylene chloride, which must be burned to avoid contamination from volatile organic compounds (VOC), resulting in high energy consumption and investment costs for incinerators.

Additionally, it requires significant energy consumption to evaporate the solvent or dry the water-based substrate, about 16 kW, depending on the weight of the substrate. It is also necessary to evaporate the solvents and extract the gases. There is a common risk of leaving residues and producing bubbles during the process.

It is difficult to control the areas where the primer is applied and to manage filament issues. In many cases, cohesive strength cannot be maintained, and the coating peels off. With water-based primers, a larger coating and drying area is required compared to solvent-based primers. The drying area for water-based primers must be tripled, and the energy required for drying is more than double that of the solvent.

Setup times are long, and in the event of a stop, the felts must be replaced because they dry out and harden. In the case of methylene chloride, wearing a mask is mandatory. Panel coatings present similar challenges, for which no effective solution has been found so far.

In the state of the art, some documents related to the field of this invention can be found, although none of them fulfill the same function or offer the same advantageous characteristics.

For example, in document ES 319 479 A3, there is a process for decorating metallic surfaces, characterized by producing anodic oxidation on the surface to be decorated until a porous oxide or metal dioxide layer is formed, with a thickness of no less than ten microns and no more than twenty microns. This layer remains solidly adhered to the metallic body, and once the porous layer is formed, decoration is carried out in the desired manner using azo dyes, aniline, or similar substances dissolved in a highly volatile liquid medium with low surface tension. In this way, the vehicle, along with the pigment, easily and quickly penetrates the pores of the metal oxide layer, causing the total evaporation or volatilization of the liquid solvent medium. Thus, only the coloring pigment is absorbed into the metal oxide layer, and once this is achieved, the final stage of fixing the color or colors is carried out using chemical and/or thermal means according to known practices.

On the other hand, document ES 2 243 856 T3 proposes a roof window with a frame structure that supports glass, comprising upper and lower horizontal elements connected by parallel lateral elements, which are at least partially wooden profiles. These wooden profiles are covered, on the sides facing outward, by protective coating elements against weathering, ensuring a watertight closure of the wooden profiles on all surfaces protruding from the roof. These coating elements are connected to the wooden profiles by means of matching and fastening methods designed and/or arranged to prevent the penetration of water and moisture into the wooden profiles.

Furthermore, document ES 474 536 A3 presents a continuous manufacturing process for closed laminated profiles, which essentially consists of passing a flat sheet, sourced from a feed coil and previously treated with lacquering or a similar coating process, through a set of profiling rollers. These rollers bend the sheet longitudinally and progressively, first creating a fold on one side, and then, once this fold is formed, bending the other side, which had already begun to fold, to form a protruding, arcuate edge. Meanwhile, the sheet progressively closes towards the opposite edge until it overlaps with it. Once folded, this will form a transverse divider, and the overlapping edges are clamped together and joined by a final punching process, which determines the final profile configuration. This, upon exiting the set of rollers, is fed into an automatic cutting machine equipped with sequential profile feeding means and adjustable to cut the profile into sections of a specified length. These sections are then subjected to the action of a die-cutting machine that continuously creates openings along the curved edge of the profile, automatically producing a completely finished profile from a flat sheet.

However, none of these documents describe a process that effectively coats profiles without the use of harmful chemicals and resolves all the previously mentioned issues.

### DETAILED DESCRIPTION OF THE INVENTION

The purpose of this invention is to provide a previously unknown solution to the aforementioned issues. Primarily, it seeks to achieve a final result that allows for a process that is more environmentally friendly and respectful of workers'health, while simultaneously reducing the filament effect produced by the adhesive and primer mixture, improving edge finishes, particularly when dealing with small radii of curvature.

The invention introduces essential innovations and significant advantages compared to the methods and processes known and used for the same purposes in the current state of the art.

The proposed process fully and satisfactorily resolves the previously mentioned problems, offering a range of advantageous and innovative features without compromising any of its performance in other aspects.

The proposed invention aims to provide an economical, ecological, practical, simple, and easy-to-use solution, whose effect would be to achieve a procedure that is more respectful of both workers'health and the environment, while optimizing processes and improving results.

In particular, the process and product according to the proposed invention present the following advantages:
It doesn't produce toxic residues and is completely harmless;
Low energy consumption: approximately 7.2 kW per device;
Since no solvents are used, there is no risk of leaving residues or producing bubbles in the finished product;
Since no solvents are used, there is no risk of contaminating the profiles;
The treated surface is controlled without the risk of contaminating uncoated areas;
No solvents are used;
Better fine-tuning of the edges without the use of primer;
The initial coupling does not produce filaments;
Compact operating machines;
Preparation times are reduced by over 50%, and in the event of a stop, there is no need to replace the felt used to apply the primer;
Reduction of downtime due to accidents;
There are no emissions of toxic gases that would endanger the operator's health.

These and other objectives are achieved with the process and the product with the characteristics specified in the attached claims.

According to the invention, a process is proposed for coating a profile or panel, comprising the following steps: a) removing the dust from the profile or panel; b) heating the profile or panel to a temperature between 30 and 70 degrees Celsius depending on the surface and thickness, using infrared halogen lamps or similar, controlled by an automatic control system; c) exposing the profile or panel to jets of ionized air by means of electric discharges with an emission frequency between 18 Hz and 25 Hz; d) coating the profile or panel with a film of polyvinyl chloride (PVC), paper, or other desired material, previously treated with a low-isocyanate emission adhesive; e) heating the profile or panel to a temperature between 45 and 65 degrees Celsius for a time depending on the mass of material in the profile or panel.

Additionally, a coated product obtained through the process described in the invention is proposed.

The present invention is primarily applicable to the coating of profiles or panels, without excluding other possible fields. According to a preferred embodiment, the coating process of the invention consists of the following steps: first, the profile or panel is cleaned of any dust present on it or adhering to it (1); then, the panel is heated to a temperature between 30 and 70 degrees Celsius, depending on its size—specifically its surface and thickness—using infrared halogen lamps (2) or similar, controlled by an automatic temperature control system to stabilize the process.

Next, the profile or panel is exposed to jets of ionized air (3) by means of electric discharges with an emission frequency between 18 Hz and 25 Hz. The ionized air jet, preferably coming from dedicated nozzles, produces a free radical exchange that facilitates the adhesion of the coating layer to the base material.

Subsequently, the profile or panel passes through a stamping zone where it is coated (4) with a film or sheet of polyvinyl chloride (PVC), paper, or other desired material, previously treated with a low-isocyanate emission adhesive.

Finally, the profile or panel passes through a conditioning chamber (5) where it is subjected to a temperature between 45 and 65 degrees Celsius for a time depending on the mass of material in the profile or panel, to accelerate and stabilize the adhesion process.

The invention also concerns a coated product, specifically a profile or panel, obtained by the process described above and claimed in the attached claims.

It is clear that the description provided is merely illustrative and not limiting, and that variations and modifications are possible without departing from the scope of protection of the invention, as defined by the attached claims.

I claim:

1. A method for coating a profile or a panel comprising the following steps:
a) removing the dust from the profile or panel;
b) heating the profile or panel to a temperature between 30 and 70 degrees Celsius depending on the surface and thickness using infrared halogen lamps or similar, controlled by an automatic control
system;
c) exposing the profile or panel to jets of ionized air by means of electric discharges with an
emission frequency between 18 Hz and 25 Hz;
d) coating the profile or panel with a film of polyvinyl chloride (PVC), paper or other desired material, previously treated with a low-isocyanate
emission adhesive;
e) heating the profile or panel at a temperature
between 45 and 65 degrees Celsius for a duration of time dependent on the mass of material in the profile or panel.

2. Coated product obtained by means of the method according to claim 1.
